(19) United States
(12) Patent Application Publication
(10) Pub. No.: US 2019/0241719 A1
(43) Pub. Date: Aug. 8, 2019

(54) HYDROPHOBING ADDITIVES

(71) Applicant: WACKER CHEMIE AG, Munich (DE)

(72) Inventor: Abdulmajid Hashemzadeh, Burghausen (DE)

(21) Appl. No.: 16/341,353

(22) PCT Filed: Oct. 12, 2016
(86) PCT No.: PCT/EP2016/074395

§ 371 Date: Apr. 11, 2019

(51) Int. Cl. C08K 9/06; C09D 5/00; C09D 7/62; C08K 9/08; C08K 3/36; C08J 3/20; C09D 143/04; C09J 143/04; C08K 5/5435; C09C 1/30

(52) U.S. Cl. CPC C08K 9/06; C09D 5/00; C09D 7/62; C08K 9/08; C08K 3/36; C08J 2343/04; C09D 143/04; C09J 143/04; C08K 5/5435; C09C 1/3081; C08J 3/203

(57) ABSTRACT

The invention relates to hydrophobing additives on the basis of silica, one or more silicone resins and one or more functionalized alkylalkoxysilanes, the alkyl groups thereof carrying at least one amino, carboxylic acid, epoxy or hydroxy group.

The present invention relates to hydrophobicizing additives based on silica, alkylalkoxysilanes bearing functional groups and silicone resins; polymer compositions containing hydrophobicizing additives and organic polymers; compositions which are based on silica and contain composite particles, alkylalkoxysilanes bearing functional groups and silicone resins and also organic polymers; processes for producing the abovementioned additives and compositions and also the use thereof in coating compositions such as paints or varnishes.

WO02004/035473 and WO2004/035474 describe silica dispersions modified with epoxysilanes as additive for polymer-containing coating compositions for improving the adhesive properties and water resistance of coatings. WO2012/022667 describes composite particles based on organic polymers, finely divided inorganic solid such as silica and also epoxysilanes for producing, for example, adhesives. Epoxysilanes are used for improving the storage stability of the silica particles or the composite particles.

WO2016/074664 describes aqueous hydrophobicizing additives comprising silanes as first active component and silicic acid derivatives such as water glass as second active component and also emulsifiers such as polydimethylsiloxane derivatives. Due to the use of the different active components, hydrophobicization of regions close to the surface and also of deeper layers of substrates is achieved simultaneously.

The addition of conventional silica-based additives to polymer-containing coating compositions disadvantageously results in coatings which have a tendency to be sticky on the surface or to soften. In the production of such coatings, leveling problems also occur to an increased extent, which can be seen on the surface of the coatings as, for example, the formation of fish eyes. Such problems are all the more pronounced when the coating compositions contain relatively large proportions of hydrophobicizing additives or in the case of unpigmented coatings.

In the light of this background, it was an object of the present invention to provide hydrophobicizing additives by means of which the abovementioned problems, in particular the surface stickiness, can be avoided or at least reduced.

The invention provides hydrophobicizing additives based on silica, one or more silicone resins and one or more alkylalkoxysilanes (functionalized alkylalkoxysilanes) whose alkyl groups bear at least one amino, carboxyl, epoxy or hydroxy group.

The hydrophobicizing additives are generally obtainable by mixing the abovementioned components. The hydrophobicizing additives can optionally contain one or more emulsifiers.

The silicone resins are preferably made up of units of the general formula RₐSi(OR′)_{b}(OH)_{c}O_{(4-a-b-c)/2},

where a=0 to 3, b=0 to 3, c=0 to 3,
where the sum of a+b+c per unit is S 3.5, preferably <3.5, and
the individual radicals R are identical or different, branched or unbranched alkyl radicals having from 1 to 22 carbon atoms, cycloalkyl radicals having from 3 to 10 carbon atoms, alkylene radicals having from 2 to 4 carbon atoms or aryl, aralkyl, alkylaryl radicals having from 6 to 18 carbon atoms and the individual radicals R′ are identical or different alkyl radicals or alkoxyalkylene radicals each having from 1 to 4 carbon atoms, preferably methyl and ethyl, where the radicals R and R′ can also be substituted by halogens such as Cl, ether, thioether, ester, amide, nitrile, hydroxyl, amine, carboxyl, sulfonic acid, carboxylic anhydride and carbonyl groups.

Preferred silicone resins are obtainable by means of a condensation reaction of
a) one or more alkylalkoxysilanes of the formula SiRₙ(OR′)₄₋ₙ
   having from 1 to 3 carbon atoms in the alkyl radical R, from 1 to 4 carbon atoms in the radical R′ and n=1 to 3 or
   one or more alkylhalosilanes of the formula SiRₙ(halogen)₄₋ₙ having from 1 to 4 carbon atoms in the radical R, having n=1 to 3 and, for example, chlorine as halogen,
b) optionally one or more alkylalkoxysilanes of the formula SiRₙ(OR′)₄₋ₘ
   having 4 to 18 carbon atoms in the alkyl radical R, from 1 to 4 carbon atoms in the radical R′ and m=1 to 3 and
c) optionally one or more further silanes.

The alkoxy groups (OR′) of the silanes preferably have 1 to 3 carbon atoms. Particular preference is given to propoxy groups and in particular methoxy and ethoxy groups.

In the interests of clarity, it may be pointed out that the silanes c) are different from the silanes a) and b).

In the case of preferred silanes a), n=1 or 2.

Examples of silanes a) are alkylalkoxysilanes such as methylalkoxysilanes, ethylalkoxysilanes or propylalkoxysilanes, or alkylhalosilanes such as methylhalosilanes or ethylhalosilanes whose alkyl radicals may optionally be substituted, for example by halogen, nitrile or mercapto groups.

Preferred silanes a) are methyltrimethoxysilane, methyltriethoxysilane, methyltripropoxysilane, dimethyldimethoxysilane, dimethyldiethoxysilane, dimethyldipropoxysilane, methyltrichlorosilane, dimethyldichlorosilane, methyltri(ethoxyethoxy)silane, dipropyldiethoxysilane, γ-chloropropyltriethoxysilane, β-nitriloethyltriethoxysilane, γ-mercaptopropyltrimethoxysilane or γ-mercaptopropyltriethoxysilane.

The proportion of the silanes a) having n=1 is preferably from 50 to 99% by weight and particularly preferably from 70 to 99% by weight, based on the dry weight of the silicone resins.

The proportion of the silanes a) having n=2 is preferably from 1 to 50% by weight and particularly preferably from 1 to 30% by weight, based on the silanes a).

The proportion of the silanes a) is preferably from 50 to 99.9% by weight, in particular from 70 to 99% by weight, based on the dry weight of the silicone resins.

In the case of preferred silanes b), m=1 or 2, in particular 1.

Examples of silanes b) are phenylalkoxysilanes, isooctylalkoxysilanes, n-octylalkoxysilanes or hexadecylalkoxysilanes.

Preferred silanes b) are phenyltriethoxysilane, methylphenyldiethoxysilane, diphenyldimethoxysilane, isooctyltriethoxysilane, n-octyltriethoxysilane or hexadecyltriethoxysilane.

The proportion of the silanes b) is preferably from 0.1 to 50% by weight, in particular from 1 to 30% by weight, based on the dry weight of the silicone resins.

Examples of silanes c) are silicic esters, preferably of the formula Si(OR′)₄, organosilanols, preferably of the formula SiRₒ(OH)₄₋ₒ. The parameter o can here assume, for example, values of from 1 to 3. Preferred silanes c) are tetramethoxysilane, tetraethoxysilane.

The proportion of the silanes c) can be, for example, from 0 to 20% by weight, in particular from 0.1 to 10% by weight, based on the dry weight of the silicone resins. Preferred silicone resins are not based on silanes c).

The silicone resins are preferably present in paste-like or cream-like form. The silicone resins are generally not polydimethylsiloxanes or substituted polydimethylsiloxanes.

The hydrophobicizing additives are preferably based to an extent of from 5 to 90% by weight, particularly preferably from 15 to 80% by weight and most preferably from 25 to 70% by weight, on silicone resin, based on the dry weight of the hydrophobicizing additives.

The silicone resins used according to the invention are commercial products or can be prepared by methods which are customary in silicon chemistry, e.g. by processes as are described in Noll, Chemie und Technologie der Silikone, 2^{nd} edition 1968, Weinheim, and in Houben-Weyl, Methoden der organischen Chemie, volume E20, Georg Thieme Verlag, Stuttgart (1987). The silicone resins mentioned can be present either alone or in admixture in the hydrophobicizing additives.

The silica is generally used in the form of sols for producing the hydrophobicizing additives. Silica sols are generally solutions or colloidal suspensions of silicon dioxide particles (SiO₂) in an aqueous medium. The silica sols preferably comprise colloidal silica, water glass or silica sols. The silica sols generally contain water as solvent and preferably do not contain any further solvents such as organic solvents. The silica sols are thus not present in solid form. The silica sols generally have pH values of from 7 to 12, in particular from 7 to 10.

The particle size of the silicon dioxide particles is preferably from 1 to 100 nm, particularly preferably from 3 to 70 nm and most preferably 5 to 50 nm (determined by means of transmission electron microscopy using the Libra 120 instrument from Zeiss).

The silica sols have a solids content of preferably from 2 to 50%, particularly preferably from 5 to 50%, even more preferably from 10 to 50% and most preferably from 20 to 50%.

The hydrophobicizing additives are preferably based to an extent of from 10 to 90% by weight, particularly preferably from 20 to 80% by weight and most preferably from 30 to 70% by weight, on silica (solid), based on dry weight of the hydrophobicizing additives.

The production of silica sols is generally known to those skilled in the art. Silica sols can be produced, for example, by hydrolysis of tetraalkoxysilanes, as described, for example, in DE-A 4124588. Tetramethoxysilanes or tetraethoxysilanes are particularly suitable for this purpose. In the production of the silica sols by hydrolysis, up to, for example, 15% by weight, preferably up to 10% by weight, particularly preferably up to 2% by weight, of organoalkoxysilanes can be added to the tetraalkoxysilanes. However, the silica sols can also be based exclusively on tetraalkoxysilanes. As an alternative, silica sols can be produced pyrogenically by flame hydrolysis, e.g. of tetrachlorosilane, as described, for example, in DE 2620737 or DE 4221716. Water glass is, for example, obtainable by melting silica sand together with alkali metal carbonates at from 1400 to 1500° C. and subsequently converting the melt into an aqueous solution.

Functionalized alkylalkoxysilanes are, for example, silanes of the general formula

(R¹O)ₚSi(R²X)₄₋ₚ (I), where

R¹ is a hydrogen atom or a hydrocarbon radical which has from 1 to 18 carbon atoms and can be interrupted by one or more nonadjacent oxygen atoms or is a radical of the formula —COCH₃, —COC₂H₅ or —CH₂CH₂OH,
R² is an optionally substituted alkylene radical which has from 1 to 20 carbon atoms, preferably from 1 to 6 carbon atoms, and in which nonadjacent methylene units can be replaced by oxygen and
X is bound via a covalent bond to R² and is an amino radical —NHR³, an epoxy radical —CR⁴(O)CR⁵R⁶, a carboxyl radical —COOH or a hydroxy radical —OH, where
R³ is a hydrogen atom or an optionally substituted alkyl, aryl or aminoalkyl radical having from 1 to 10 carbon atoms,
R⁴, R⁵, R⁶ are each a hydrogen atom or an optionally substituted alkyl or aryl radical having from 1 to 10 carbon atoms,
Where the respective radicals R¹, R², R³, R⁴, R⁵ and R⁶ can each assume their meanings independently of one another and R²X is bound via a carbon atom of the radical R² to the silicon atom in the formula I.

Examples of hydrocarbon radicals R¹ in the formula I are alkyl radicals such as the methyl, ethyl, n-propyl, isopropyl, n-butyl, sec-butyl, amyl, hexyl, β-ethylhexyl, heptyl, octyl, isooctyl or octadecyl radical; alkenyl radicals such as the vinyl and allyl radical and butenyl radicals; alkynyl radicals; cycloalkyl radicals such as the cyclobutyl or cyclohexyl radical and methylcyclohexyl radicals; aryl radicals such as the phenyl radical; alkaryl radicals such as tolyl radicals; and aralkyl radicals such as the benzyl radical. Particular preference is given to the methyl, ethyl, vinyl and phenyl radicals.

The radicals R² of the group R²X of the functionalized alkylalkoxysilanes of the formula I are preferably not substituted. R² is particularly preferably an alkylene radical having from 1 to 6 carbon atoms, most preferably methylene, ethylene or propylene.

R³ is preferably a hydrogen atom, an alkyl, aryl or aminoalkyl radical having from 1 to 6 carbon atoms, particularly preferably a hydrogen atom, 2-aminoethyl, phenyl, cyclohexyl, methyl, ethyl, propyl or butyl. The radicals R⁴, R⁵, R⁷ are each preferably a hydrogen atom.

In the case of preferred functionalized alkylalkoxysilanes, p assumes values of from 1 to 3, in particular 1 or 2.

The individual radicals R¹, R², R³, R⁴, R⁵, R⁶ and X and also p of the compounds of the formula I assume their meanings in each case independently of one another. In all embodiments of the formula I, the silicon atom is in each case tetravalent.

Preference is given to aminoalkylenetrialkoxysilanes and in particular glycidoxyalkylenetrialkoxysilanes of the formula I. Examples of preferred functionalized alkylalkoxysilanes of the formula I are (3-aminopropyl)triethoxysilane, (3-aminopropyl)trimethoxysilane, N-(2-aminoethyl)(3-aminopropyl)triethoxysilane, N-(2-aminoethyl) (3-aminopropyl)trimethoxysilane, N-(2-aminoethyl)(3-aminopropyl)methyldimethoxysilane, N-cyclohexylaminomethylmethyldiethoxysilane, (3-glycidoxypropyl)triethoxysilane, 3-glycidoxypropyl)trimethoxysilane. Preference is given to (3-aminopropyl)triethoxysilane and 3-glycidoxypropyl)triethoxysilane. Particular preference is given to epoxy radicals, in particular (3-glycidoxypropyl)triethoxysilane.

To produce the hydrophobicizing additives, the functionalized alkylalkoxysilanes are preferably used in an amount of from 0.1 to 10% by weight, particularly preferably from 1 to 9% by weight and most preferably from 2.0 to 8% by weight, based on the dry weight of the silica.

To produce the hydrophobicizing additives, the functionalized alkylalkoxysilanes are preferably used in an amount of from 0.1 to 10% by weight, particularly preferably from 0.5 to 8% by weight and most preferably from 1 to 6% by weight, based on the dry weight of silicone resins and silica.

In the hydrophobicizing additives, the functionalized alkylalkoxysilanes are preferably bound covalently via siloxane bonds (Si—O—Si) to silica and/or silicone resins. The functionalized alkylalkoxysilanes are preferably not bound via a carbon atom to silica and/or silicone resins.

Furthermore, the hydrophobicizing additives can contain emulsifiers. Anionic, cationic or nonionic emulsifiers in general are suitable. Examples of anionic surfactants are alkyl sulfates having a chain length of from 8 to 18 carbon atoms, alkyl or alkylaryl ether sulfates having from 8 to 18 carbon atoms in the hydrophobic radical and up to 40 ethylene oxide or propylene oxide units, alkylsulfonates or alkylarylsulfonates having from 8 to 18 carbon atoms, esters and half esters of sulfosuccinic acid with monovalent alcohols or alkyl phenols. Examples of nonionic surfactants are alkyl polyglycol ethers; alkyl aryl polyglycol ethers having from 8 to 40 ethylene oxide units; or polydimethylsiloxane-based emulsifiers such as polyethylene- or polypropylene-substituted polydimethylsiloxanes, in particular cetyl-polyethylene- or cetyl-polypropylene-substituted polydimethylsiloxanes, or glyceryl/lauryl-substituted polydimethylsiloxanes.

Preference is given to from 0 to 15% by weight and particularly preferably from 1 to 10% by weight of emulsifiers being present, based on the dry weight of the hydrophobicizing additives.

The hydrophobicizing additives can also contain one or more protective colloids. The proportion of the protective colloids is, for example, from 1 to 20% by weight, preferably 1% by weight and particularly preferably 0.5% by weight, based on the dry weight of the hydrophobicizing additives. Greatest preference is given to no protective colloids being present.

Examples of protective colloids are polyvinylpyrrolidones; polyvinyl acetals; polysaccharides in water-soluble form, e.g. starches (amylose and amylopectin), celluloses or derivatives thereof, e.g. carboxymethyl, methyl, hydroxyethyl, hydroxypropyl derivatives; proteins such as caseine or caseinate, soya protein, gelatin; lignosulfonates; synthetic polymers such as poly(meth)acrylic acid, copolymers of (meth)acrylates with carboxyl-functional comonomer units, poly(meth)acrylamide, polyvinylsulfonic acids and water-soluble copolymers thereof; melamine-formaldehyde sulfonates, naphthalene-formaldehyde sulfonates, styrene-maleic acid and vinyl ether-maleic acid copolymers, in particular partially hydrolyzed or fully hydrolyzed polyvinyl alcohols. The protective colloids are commercially available and can be obtained by means of processes known to a person skilled in the art.

Furthermore, the hydrophobicizing additives can contain one or more further additions, for example further binders, pigments, fillers, in particular zeolites, thickeners, antifoams, foam stabilizers, air pore formers or preservatives.

The hydrophobicizing additives have a viscosity of preferably from 1.5 to 1000 mPas, particularly preferably from 2 to 500 mPas and most preferably from 4 to 200 mPas (determined using a Brookfield viscometer, at 20° C., as 40% strength S dispersion in water, using spindle 1 or 2 at 20 revolutions per minute).

The hydrophobicizing additives are, for example, present in the form of dispersions, in particular aqueous dispersions.

The solids content of the hydrophobicizing additives in the form of dispersions is preferably from 10 to 70% by weight, particularly preferably from 25 to 65% by weight and most preferably from 30 to 60% by weight.

As an alternative, the hydrophobicizing additives can also be present in the form of powders.

The invention further provides a process for producing the hydrophobicizing additives, characterized in that silica, one or more silicone resins and one or more alkylalkoxysilanes (functionalized alkylalkoxysilanes), whose alkyl groups bear at least one amino, carboxyl, epoxy or hydroxy group are mixed.

The individual components for producing the hydrophobicizing additives can be mixed in any order. Individual components or all components can be initially charged or entirely or partly introduced spatially separately or spatially together. The mixing apparatuses customary in the present technical field can be used.

The silicone resins and the functionalized alkylalkoxysilanes can, for example, be used in pure form or in a solvent, in particular in water, preferably in the form of an aqueous dispersion or emulsion. Silica is preferably used in the form of aqueous silica sols.

Mixing is preferably carried out at from 5 to 70° C., particularly preferably from 15 to 65° C. and most preferably from 35 to 60° C. The temperatures mentioned are particularly advantageous in order to obtain stable products.

The pH during mixing is preferably in the range from 6 to 14, particularly preferably from 7 to 12 and most preferably from 8 to 11. The pH can be set in a known manner by means of organic or inorganic acids, bases or buffers, for example by addition of hydrochloric acid, ammonia or alkali metal hydroxides, for example sodium hydroxide.

The duration of mixing is, for example, from 1 to 10 hours, preferably from 2 to 8 hours and particularly preferably from 2 to 8 hours or from 3 to 6 hours. If mixing is carried out at temperatures of ≥30° C., the duration of mixing is preferably from 2 to 6 hours and particularly preferably from 3 to 5 hours. If mixing is carried out at temperatures of <30° C., the duration of mixing is preferably from 4 to 8 hours and particularly preferably from 5 to 7 hours.

Mixing is preferably carried out in an aqueous medium. Preference is given to using exclusively water as solvent.

Hydrophobicizing additives which can be obtained in this way are preferably present in the form of dispersions, in particular aqueous dispersions.

To produce the hydrophobicizing additives in the form of powders, it is possible to dry dispersions of the hydrophobicizing additives, preferably with addition of drying aids. Suitable drying aids are, for example, the abovementioned protective colloids, in particular polyvinyl alcohol. Suitable drying methods are, for example, fluidized-bed drying, roller drying, freeze drying or spray drying. The dispersions are preferably spray dried. Spray drying is carried out in conventional spray drying plants, with atomization being able to be carried out by means of single-fluid, two-fluid or multifluid nozzles or by means of a rotating disk. The outlet temperature is generally selected in the range from 45° C. to 120° C., preferably from 60° C. to 90° C.

A content of up to 1.5% by weight of antifoam, based on the solids content of the dispersion, has frequently been found to be useful for drying. To increase the storage capability by improving the blocking stability, the powder obtained can be provided with an antiblocking agent (anticaking agent), preferably in an amount of up to 30% by weight, based on the solids content of the dispersion. Examples of antiblocking agents are Ca carbonate or Mg carbonate, talc, gypsum, silicas such as highly disperse silicas, kaolins, metakaolin, calcined kaolin, silicates having particle sizes of preferably from 10 nm to 100 μm.

Further additions are preferably added during or after drying of the dispersion.

The viscosity of the dispersion to be dried can, for example, be set via the solids content in such a way that a value of ≤1500 mPas (Brookfield viscosity at 20 revolutions and 23′C), preferably ≤500 mPas, is obtained.

The invention further provides polymer compositions containing one or more polymers of ethylenically unsaturated monomers, characterized in that one or more hydrophobicizing additives according to the invention are present.

The polymer compositions preferably contain from 1 to 40% by weight, particularly preferably from 2 to 30% by weight and most preferably from 5 to 25% by weight, of hydrophobicizing additives, based on the dry weight of the polymer compositions (i.e. dry/dry).

The polymer compositions preferably contain from 60 to 99% by weight, particularly preferably from 70 to 98% by weight and most preferably from 75 to 95% by weight, of polymers of ethylenically unsaturated monomers, in particular polymers in the form of protective colloid-stabilized aqueous dispersions or preferably in the form of protective colloid-stabilized powders, based on the dry weight of the polymer compositions (i.e. dry/dry).

The solids content of the polymer compositions in the form of dispersions is preferably from 10 to 70% by weight, particularly preferably from 30 to 65% by weight and most preferably from 40 to 60% by weight.

The polymer compositions are preferably present in dry form, in particular in the form of powders which are redispersible in water.

Suitable ethylenically unsaturated monomers are, for example, selected from the group consisting of vinyl esters, (meth)acrylic esters, vinylaromatics, olefins, 1,3-dienes and vinyl halides and optionally further monomers which are copolymerizable therewith, for example ethylenically unsaturated silanes.

Suitable vinyl esters are, for example, esters of carboxylic acids having from 1 to 15 carbon atoms. Preference is given to vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids having from 9 to 11 carbon atoms, for example VeoVa9^{R} or VeoVa10^{R} (trade names of Resolution). Particular preference is given to vinyl acetate.

Suitable monomers from the group consisting of acrylic esters and methacrylic esters are, for example, esters of unbranched or branched alcohols having from 1 to 15 carbon atoms.

Preferred methacrylic esters or acrylic esters are methyl acrylate, methyl methacrylate, ethyl acrylate, ethyl methacrylate, propyl acrylate, propyl methacrylate, n-butyl acrylate, n-buyl methacrylate, t-butyl acrylate, t-butyl methacrylate, 2-ethylhexyl acrylate. Particular preference is given to methyl acrylate, methyl methacrylate, n-butyl acrylate, t-butyl acrylate and 2-ethylhexyl acrylate.

Preferred vinylaromatics are styrene, methylstyrene and vinyltoluene. A preferred vinyl halide is vinyl chloride.

Preferred olefins are ethylene, propylene and preferred dienes are 1,3-butadiene and isoprene.

Preferred copolymerizable monomers are ethylenically unsaturated silanes, for example silanes of the general formula (1) R⁷SiR₀₋₂(OR⁹)₁₋₃, where R⁷ is CH₂═CR¹⁰—(CH₂)₀₋₁ or CH₂═CR¹⁰CO₂(CH₂)₁₋₃, R⁸ is a C₁-C₃-alkyl radical, C₁-C₃-alkoxy radical or halogen, preferably Cl or Br, R⁹ is an unbranched or branched, optionally substituted alkyl radical having from 1 to 12 carbon atoms, preferably from 1 to 3 carbon atoms, or an acyl radical having from 2 to 12 carbon atoms, with R⁹ optionally being able to be interrupted by an ether group, and R¹⁰ is H or CH₃.

Polymers which contain monomer units of ethylenically unsaturated silanes will hereinafter also be referred to as silane-containing copolymers.

Preferred ethylenically unsaturated silanes of the formula (1) are γ-acryloxypropyltri(alkoxy)silanes or γ-methacryloxypropyltri(alkoxy)silanes, α-methacryloxymethyltri(alkoxy)silanes, γ-methacryloxypropylmethyldi(alkoxy)silanes; vinylsilanes such as vinylalkyldi(alkoxy)silanes and vinyltri(alkoxy)silanes, with, for example, methoxy, ethoxy, methoxyethylene, ethoxyethylene, methoxypropylene glycol ether or ethoxypropylene glycol ether radicals being able to be used as alkoxy groups. Examples of preferred unsaturated silanes of the formula (1) are 3-methacryloxypropyltrimethoxysilane, 3-methacryloxypropylmethyldimethoxysilane, vinyltrimethoxysilane, vinylmethyldimethoxysilane, Vinyltriethoxysilane, vinylmethyldietheoxysilane, vinyltripropoxysilane, vinyltriisopropoxysilane, vinyltris(l-methoxy)isopropoxysilane, vinyltributoxysilane, vinyltriacetoxysilane, methacryloxymethyltrimethoxysilane, 3-methacryloxypropyltris(2-methoxyethoxy)silane, vinyltrichlorosilane, vinylmethyldichlorosilane, vinyltris(2-methoxyethoxy)silane, trisacetoxyvinylsilane, allylvinyltrimethoxysilane, allyltriacetoxysilane, vinyldimethylmethoxysilane, vinyldimethylethoxysilane, vinylmethyldiacetoxysilane, vinyldimethylacetoxysilane, vinylisobutyldimethoxysilane, vinyltriisopropyloxysilane, vinyltributoxysilane, vinyltrihexyloxysilane, vinylmethoxydihexoxysilane, vinyltrioctyloxysilane, vinyldimethoxyoctyloxysilane, vinylmethoxydioctyloxysilane, vinylmethoxydilauryloxysilane, vinyldimethoxylauryloxysilane and also polyethylene glycol-modified vinylsilanes.

As ethylenically unsaturated silanes of the formula (1), particular preference is given to vinyltrimethoxysilane, vinylmethyldimethoxysilane, vinyltriethoxysilane, vinylmethyldiethoxysilane, vinyltris(1-methoxy)isopropoxysilane, methacryloxypropyltris(2-methoxyethoxy)silane, 3-methacryloxypropyltrimethoxysilane, 3-methacryloxypropylmethyldimethoxysilane and methacryloxymethyltrimethoxysilane and also mixtures thereof.

The polymers are preferably based to an extent of from 0 to 5% by weight, particularly preferably from 0.1 to 3% by weight and most preferably from 0.3 to 2% by weight, on ethylenically unsaturated silanes, based on the total weight of the polymers.

In addition from 1 to 15% by weight, preferably from 2 to 15% by weight, particularly preferably 3 to 10% by weight, based on the total weight of the monomer mixture of auxiliary monomers can optionally be copolymerized. Examples of auxiliary monomers are ethylenically unsaturated monocarboxylic and dicarboxylic acids, preferably acrylic acid, methacrylic acid, fumaric acid and maleic acid; ethylenically unsaturated carboxamides and carboxylic nitriles, preferably acrylamide and acrylonitrile; monoesters and diesters of fumaric acid and maleic acid, e.g. the diethyl and diisopropyl esters, and also maleic anhydride; ethylenically unsaturated sulfonic acids or salts thereof, preferably vinylsulfonic acid, 2-acrylamido-2-methylpropanesulfonic acid. Further examples are precrosslinking comonomers such as multiply ethylenically unsaturated comonomers, for example diallyl phthalate, divinyl adipate, diallyl maleate, allyl methacrylate or triallyl cyanurate, or post-crosslinking comonomers, for example acrylamidoglycolic acid (AGA), methyl methylacrylamidoglycolate (MAGME), N-methylolacrylamide (NMA), N-methylolmethacrylamide, allyl N-methylolcarbamate, alkyl ethers such as the isobutoxy ether or ester of N-methylolacrylamide, of N-methylolmethacrylamide and of allyl N-methylolcarbamate. Epoxide-functional comonomers such as glycidyl methacrylate and glycidyl acrylate are also suitable. Further examples are monomers having hydroxy or CO groups, for example hydroxy alkyl methacrylates and acrylates, e.g. hydroxyethyl, hydroxypropyl or hydroxybutyl acrylate or methacrylate, and also compounds such as diacetoneacrylamide and acetylacetoxyethyl acrylate or methacrylate.

The selection of monomers and the selection of the proportions by weight of the comonomers is carried out in such a way that a glass transition temperature Tg of from −50° C. to +50° C., preferably from −20° C. to +30° C., generally results. The glass transition temperature Tg of the polymers can be determined in a known manner by means of DSC (differential scanning calorimetry, DIN EN ISO 11357-1/2), for example using the differential scanning calorimeter DSC1 from Mettler-Toledo in open crucibles at a heating rate of 10 K/min. The temperature at the midpoint of the step in the heat flow diagram (midpoint=half step height of the heat flow step) in the second heating curve is taken as glass transition temperature. The Tg can also be approximately calculated beforehand by means of the Fox equation. According to Fox T. G., Bull. Am. Physics Soc. 1, 3, page 123 (1956): 1/Tg=x₁/Tg₁+x₂/Tg₂+ . . . +xₙ/Tgₙ, where xₙ is the mass fraction (% by weight/100) of the monomer n and Tgₙ is the glass transition temperature in kelvin of the homopolymer of the monomer n. Tg values for homopolymers are given in the Polymer Handbook 2nd Edition, J. Wiley & Sons, New York (1975).

Preference is given to copolymers of vinyl acetate with from 1 to 50% by weight of ethylene; copolymers of vinyl acetate with from 1 to 50% by weight of ethylene and from 1 to 50% by weight of one or more further comonomers from the group consisting of vinyl esters having from 1 to 12 carbon atoms in the carboxylic acid radical, e.g. vinyl propionate, vinyl laurate, vinyl esters of alpha-branched carboxylic acids having from 9 to 13 carbon atoms, e.g. VeoVa9, VeoVa10, VeoVa11; copolymers of vinyl acetate, from 1 to 50% by weight of ethylene and preferably from 1 to 60% by weight of (meth)acrylic esters of unbranched or branched alcohols having from 1 to 15 carbon atoms, in particular n-butyl acrylate or 2-ethylhexyl acrylate; and copolymers comprising from 30 to 75% by weight of vinyl acetate, from 1 to 30% by weight of vinyl laurate or vinyl esters of an alpha-branched carboxylic acid having from 9 to 11 carbon atoms, and also from 1 to 30% by weight of (meth)acrylic esters of unbranched or branched alcohols having from 1 to 15 carbon atoms, in particular n-butyl acrylate or 2-ethylhexyl acrylate, which additionally contain from 1 to 40% by weight of ethylene; copolymers comprising vinyl acetate, from 1 to 50% by weight of ethylene and from 1 to 60% by weight of vinyl chloride; where the copolymers can additionally contain the abovementioned ethylenically unsaturated silanes and/or auxiliary monomers in the amounts indicated and the % by weight in each case add up to 100% by weight.

Preference is also given to (meth)acrylic ester polymers such as copolymers of n-butyl acrylate or 2-ethylhexyl acrylate or copolymers of methyl methacrylate with n-butyl acrylate and/or 2-ethylhexyl acrylate; styrene-acrylic ester copolymers comprising one or more monomers from the group consisting of methyl acrylate, ethyl acrylate, propyl acrylate, n-butyl acrylate, 2-ethylhexyl acrylate; vinyl acetate-acrylic ester copolymers comprising one or more monomers from the group consisting of methyl acrylate, ethyl acrylate, propyl acrylate, n-butyl acrylate, 2-ethylhexyl acrylate and optionally ethylene; styrene-1,3-butadiene copolymers; where the copolymers can additionally contain the abovementioned ethylenically unsaturated silanes and/or auxiliary monomers in the amounts indicated and the % by weight in each case add up to 100% by weight.

Particular preference is given to copolymers comprising vinyl acetate and from 5 to 50% by weight of ethylene, or copolymers comprising vinyl acetate, from 1 to 50% by weight of ethylene and from 1 to 50% by weight of a vinyl ester of α-branched monocarboxylic acids having from 9 to 11 carbon atoms, or copolymers comprising from 30 to 75% by weight of vinyl acetate, from 1 to 30% by weight of vinyl laurate or vinyl esters of an alpha-branched carboxylic acid having from 9 to 11 carbon atoms, and also from 1 to 30% by weight of (meth)acrylic esters of unbranched or branched alcohols having from 1 to 15 carbon atoms, which additionally contain from 1 to 40% by weight of ethylene, or copolymers comprising vinyl acetate, from 5 to 50% by weight of ethylene and from 1 to 60% by weight of vinyl chloride; where the copolymers can additionally contain the abovementioned ethylenically unsaturated silanes and/or auxiliary monomers in the amounts indicated and the % by weight in each case add up to 100% by weight.

Particular preference is also given to (meth)acrylic ester copolymers such as copolymers of (meth)acrylic esters such as methyl (meth)acrylate and/or butyl (meth)acrylate, optionally from 1 to 15% by weight, preferably from 2 to 15% by weight, particularly preferably from 3 to 10% by weight, of ethylenically unsaturated carboxylic acids, such as crotonic acid, fumaric acid, vinylsulfonic acid, vinylbenzenesulfonic acid, acrylamido-2-methylpropanesulfonic acid, in particular acrylic acid, methacrylic acid, itaconic acid and maleic acid; where the copolymers mentioned can additionally contain from 0 to 50% by weight, preferably from 0.1 to 50% by weight, particularly preferably from 1 to 30% by weight, of styrene and the % by weight in each case add up to 100% by weight.

Particular preference is also given to 2-ethylhexyl acrylate copolymers of from 20 to 60% by weight, in particular from 29 to 55% by weight of 2-ethylhexyl acrylate; from 0 to 40% by weight, in particular from 5 to 30% by weight, of one or more monomers from the group consisting of n-butyl acrylate, n-hexyl acrylate, n-hexyl methacrylate, 2-ethylhexyl methacrylate and butadiene; from 30 to 70% by weight, in particular from 40 to 60% by weight, of one or more monomers from the group consisting of acyl nitrile, α-methylstyrene, tert-butyl methacrylate, tert-butyl acrylate, lauryl acrylate, stearyl acrylate and in particular styrene, methyl methacrylate; up to 10% by weight, in particular from 0.5 to 6% by weight, of one or more monomers containing acid groups, e.g. crotonic acid, fumaric acid, vinylsulfonic acid, vinylbenzenesulfonic acid, acrylamido-2-methylpropanesulfonic acid, in particular acrylic acid, methacrylic acid, itaconic acid and maleic acid; and optionally from 0 to 5% by weight, in particular 0.1 to 5% by weight, of one or more monomers having at least one hydroxy and/or keto group in the side chain and/or ethylenically unsaturated silanes, e.g. hydroxyethyl (meth)acrylate, hydroxypropyl (meth)acrylate, glycidyl (meth)acrylate, vinylsilanes, glycidyloxypropyltrimethoxysilane or N-methylolacrylamide; where the % by weight in each case add up to 100% by weight.

As silane-containing copolymers, particular preference is given to copolymers of vinyl esters, in particular vinyl acetate, with from 0.1 to 5% by weight, preferably from 0.1 to 3% by weight, particularly preferably from 0.2 to 2% by weight, of ethylenically unsaturated silanes, e.g. vinyltrimethoxysilane, vinyltriethoxysilane, vinylmethyldimethoxysilane or vinylmethyldiethoxysilane, and optionally from 1 to 15% by weight, preferably from 2 to 15% by weight, particularly preferably from 3 to 10% by weight, of ethylenically unsaturated carboxylic acids such as crotonic acid, fumaric acid, vinylsulfonic acid, vinylbenzenesulfonic acid, acrylamido-2-methylpropanesulfonic acid, in particular acrylic acid, methacrylic acid, itaconic acid and maleic acid; where the copolymers mentioned can additionally contain from 5 to 45% by weight of butyl acrylate, ethylene or vinyl esters of α-branched monocarboxylic acids having from 9 to 11 carbon atoms, e.g. VeoVa9 or VeoVa10, and the % by weight in each case add up to 100% by weight.

As silane-containing copolymers, particular preference is also given to copolymers of (meth)acrylic esters such as methyl (meth)acrylate and/or n-butyl (meth)acrylate, from 0.1 to 5% by weight, preferably from 0.1 to 3% by weight, particularly preferably from 0.2 to 2% by weight, of ethylenically unsaturated silanes, e.g. vinyltrimethoxysilane, vinyltriethoxysilane, vinylmethyldimethoxysilane or vinylmethyldiethoxysilane, and optionally from 1 to 15% by weight, preferably from 2 to 15% by weight, particularly preferably from 3 to 10% by weight, of ethylenically unsaturated carboxylic acids such as crotonic acid, fumaric acid, vinylsulfonic acid, vinylbenzenesulfonic acid, acrylamido-2-methylpropanesulfonic acid, in particular acrylic acid, methacrylic acid, itaconic acid and maleic acid; where the copolymers mentioned can additionally contain from 0 to 50% by weight, preferably from 0.1 to 50% by weight, particularly preferably from 1 to 30% by weight, of styrene and the % by weight in each case add up to 100% by weight.

Greatest preference is given to (meth)acrylic ester polymers, in particular 2-ethylhexyl acrylate copolymers, or silane-containing copolymers.

The polymers are generally prepared in an aqueous medium and preferably by the suspension polymerization process or in particular by the emulsion polymerization process, as described, for example in DE-A 102008043988. The polymers are obtained in the form of aqueous dispersions. In the polymerization, it is possible to use the customary emulsifiers and/or preferably protective colloids, in particular the abovementioned emulsifiers or protective colloids, as described in DE-A 102008043988. Polymers in the form of protective colloid-stabilized aqueous dispersions are thus preferred. The aqueous dispersions preferably contain a total of from 1 to 20% by weight of protective colloids, based on the total weight of the monomers added.

The polymers in the form of aqueous dispersions can be converted into powders which are redispersible in water, in a manner analogous to that described above for the drying for producing the hydrophobicizing additives in the form of powders. The redispersible powders generally contain a drying aid in a total amount of from 3 to 30% by weight, preferably from 5 to 20% by weight, based on the total weight of the redispersible polymer powders. The abovementioned polyvinyl alcohols are preferred as drying aid. Polymers in the form of protective colloid-stabilized powders which are redispersible in water are thus preferred.

The viscosity of the feed to be atomized is set via the solids content in such a way that a value of <500 mPas (Brookfield viscosity at 20 revolutions and 23° C.), preferably <250 mPas, is usually obtained. The solids content of the dispersion to be atomized is preferably from 30 to 75% by weight and particularly preferably from 50 to 60% by weight.

The polymers in the form of powders which are redispersible in water can additionally contain the abovementioned antifoams, antiblocking agents (anticaking agents) and optionally further additions, for example in the abovementioned amounts.

The invention further provides a process for producing the polymer compositions, characterized in that one or more hydrophobicizing additives according to the invention or individual constituents thereof are mixed with one or more polymers of ethylenically unsaturated monomers.

The mixing of the polymers and the hydrophobicizing additives or the mixing of the polymers and the individual constituents according to the invention of the hydrophobicizing additives is not tied to any particular procedure or apparatus and can be carried out in a conventional way in the customary mixing vessels.

For example, hydrophobicizing additives in the form of aqueous dispersions or powders and polymers in the form of aqueous dispersions or powders which are redispersible in water can be mixed. Preference is given to mixing hydrophobicizing additives in the form of aqueous dispersions and polymers in the form of aqueous dispersions or powders which are redispersible in water and subsequently optionally drying the mixtures. Silica, silicone resins, functionalized alkylalkoxysilanes and optionally emulsifiers, either separately or in premixed form, optionally in an aqueous solvent, can also be mixed with polymers in the form of aqueous dispersions or powders which are redispersible in water and optionally be dried subsequently. Drying can here be carried out as described above for the hydrophobicizing additives or for the polymers, optionally with addition of antifoams, antiblocking agents or the abovementioned further additions. One or more protective colloids is/are preferably added before drying.

The invention further provides compositions which contain composite particles and are based on silica, one or more silicone resins, one or more alkylalkoxysilanes (functionalized alkylalkoxysilanes) whose alkyl groups bear at least one amino, carboxyl, epoxy or hydroxy group and one or more silane-containing copolymers, in particular one or more protective colloid-stabilized silane-containing copolymers, optionally one or more emulsifiers with one or more composite particles obtainable by condensation of silica and/or silicone resins with one or more silane-containing copolymers, in particular one or more protective colloid-stabilized silane-containing copolymers, in an aqueous solvent, with one or more silane-containing copolymers being fixed onto silica and/or silicone resins as a result of the condensation, being present.

Composite particles generally contain organic and inorganic domains, for example an organic polymer matrix and inorganic domains such as silica or silicone resins fixed thereto. Composite particles usually have diameters of from 4 to 5000 nm. As a result of the condensation according to the invention, the organic domains are formed essentially by the silane-containing copolymers and the inorganic domains are formed essentially by silica and/or silicone resins.

The composite particles are present in amounts of preferably ≥70% by weight, particularly preferably from 75 to 99% by weight and most preferably from 80 to 95% by weight, in the compositions containing composite particles, based on the dry weight of the compositions containing composite particles.

The compositions containing composite particles are preferably based on from 70 to 95% by weight, in particular from 75 to 90% by weight, of silane-containing copolymers, in particular protective colloid-stabilized silane-containing copolymers, based on the dry weight of the compositions containing composite particles.

The compositions containing composite particles are preferably based on from 2 to 40% by weight, in particular from 5 to 15% by weight, of silica (solid), based on the dry weight of the compositions containing composite particles.

The compositions containing composite particles are preferably based on from 10 to 85% by weight, in particular from 25 to 70% by weight, silicone resin, from 10 to 85% by weight, in particular from 25 to 70% by weight, of silica (solid), based on the dry weight of silicone resin, silica and the functionalized alkylalkoxysilanes.

The compositions containing composite particles are preferably based on from 0.1 to 10% by weight, in particular from 1 to 6% by weight, of functionalized alkylalkoxysilanes, based on the dry weight of silicone resins and silica.

The compositions containing composite particles can optionally also contain from 0 to 15% by weight, in particular from 1 to 10% by weight, of emulsifiers, based on the dry weight of silicone resin, silica and functionalized alkylalkoxysilanes.

The aqueous solvents preferably contain water and optionally one or more organic solvents. Examples of organic solvents are alcohols having from 1 to 6 carbon atoms, e.g. methanol, ethanol, n-propanol or i-propanol, ketones such as acetone or methyl ethyl ketone, esters such as methyl acetate, ethyl acetate, propyl acetate or butyl acetate. Particularly preferred aqueous solvents contain 40% by weight, particularly preferably 20% by weight and most preferably ≤10% by weight, of organic solvents, based on the total weight of the aqueous solvents. Mostly, aqueous solvents which do not contain any organic solvents are used for producing the compositions containing composite particles.

The compositions containing composite particles can additionally contain the abovementioned further additions, for example in the abovementioned amounts.

The compositions containing composite particles can, for example, be present in the form of aqueous dispersions or in the form of powders which are redispersible in water.

The solids content of the compositions containing composite particles in the form of aqueous dispersions is preferably from 10 to 70% by weight, particularly preferably from 30 to 65% by weight and most preferably from 40 to 60% by weight.

The compositions containing composite particles in the form of powders which are redispersible in water can additionally contain the abovementioned antifoams, antiblocking agents (anticaking agents) and optionally further additions, for example in the abovementioned amounts.

The invention further provides a process for producing the compositions containing composite particles by mixing silica, one or more silicone resins, one or more alkylalkoxysilanes (functionalized alkylalkoxysilanes) whose alkyl groups bear at least one amino, carboxyl, epoxy or hydroxy group and one or more silane-containing copolymers, in particular one or more protective colloid-stabilized silane-containing copolymers in an aqueous solvent, with composite particles being formed by a condensation reaction of silica and/or silicone resins with silane-containing copolymers, in particular protective colloid-stabilized silane-containing copolymers, and silane-containing copolymers being fixed on silica and/or silicone resins as a result of the condensation reaction.

The condensation of the silane-containing copolymers onto silica and/or silicone resins or the mixing of the individual constituents of the compositions containing composite particles can be carried out in an analogous manner and under the conditions described above for the production of the polymer compositions or the hydrophobicizing additives. The composite particles can be formed in situ during mixing of the individual constituents of the compositions containing composite particles. As an alternative, it is also possible firstly to produce the composite particles by condensation of silica and/or silicone resins with silane-containing copolymers and subsequently mix the resulting composite particles with the further constituents of the composite particles. Mixing is preferably carried out in the presence of one or more emulsifiers.

The compositions containing composite particles in the form of aqueous dispersions can be converted by drying into compositions containing composite particles in the form of powders which are redispersible in water. Drying can, for example, be carried out as described above for the hydrophobicizing additives or for polymers, optionally with addition of antifoams, antiblocking agents or the abovementioned further additions.

The hydrophobicizing additives according to the invention are suitable as additive for polymer compositions or coating compositions such as pigmented or unpigmented systems, for example as clear varnish or in paints or sealants. The polymer compositions of the invention or compositions containing composite particles can be used directly as clear varnish or generally also as binders or are suitable as additive for coating compositions. Such coating compositions are preferably cement-free, or coating compositions in general which do not contain any hydraulic binders. Such coating compositions can serve, for example, as paints, varnishes or glazes, for example for mineral substrates such as concrete, screeds, render or gypsum plaster, ceramic, natural stone or artificial stone and in particular for wood or wood materials, for example wooden wall paneling or furniture. However, the coating compositions can also be employed in the coating of fibers, textiles or paper.

The surface of substrates can be hydrophobicized by means of coating compositions which have been hydrophobicized according to the invention.

The coatings which are obtainable according to the invention are hydrophobic, i.e. water-repellent, and nevertheless permeable to water vapor. In addition, coatings having improved thermal stability or improved water, fire or mechanical resistance are obtainable.

Surprisingly, the coating compositions of the invention make polymer-containing, hydrophobicized coatings having a low surface stickiness obtainable. Such coatings also have a reduced tendency to soften on heating. In addition, a lesser degree of leveling problems occurs on application of the coating compositions to substrates, for which reason fewer fish eyes are formed on the surface of the coatings and thus coatings having a more homogeneous appearance are formed.

These effects manifest themselves more significantly, the larger the proportions of additives or compositions according to the invention are present in the coating compositions. In the case of unpigmented coating compositions, too, these effects manifest themselves to a particularly significant extent. The silica, the silicone resins and the functionalized alkylalkoxysilanes or the composite particles according to the invention contribute synergistically to all these effects.

It is also advantageous that the additives and compositions according to the invention are obtainable in solid form. This aids handling of the products during application. In contrast, conventional hydrophobicizing additives, for example silicones, can be liquid or even be present in the form of honey-like, viscous pastes, which is considered disadvantageous by users.

In addition, the inventive additives and compositions and also coating compositions have a surprisingly high storage stability. Phase separation of different components or gelling during storage has not been observed.

The following examples serve to illustrate the invention in detail and are not to be construed as restricting the invention in any way.

### Production of the Hydrophobicizing Agents:

Deionized water, the aqueous silicone resin emulsion Silres BS 60 (trade name of Wacker Chemie; solids content 60% by weight), the aqueous silica sol Bindzil 2040 (trade name of AKZO-NOBEL; solids content 40% by weight) and optionally 3-glycidoxypropyltrimethoxysilane (Geniosil GF 80, trade name of Wacker Chemie) were, in accordance with the data in Table 1, placed in a reactor having a volume of three liters, heated to 50° C. while stirring and stirred at this temperature for five hours. After cooling to room temperature, dispersions having a solids content of 40% by weight were obtained.

TABLE 1
Formulations for producing the hydrophobicizing
agents of (comparative) examples 1 to 4:

| | | Silres | Silica sol | Geniosil | |
|---|---|---|---|---|---|
| | Water | BS 60 | Bindzil 2040 | GF 80 | Viscosity |
| | [g] | [g] | [g] | [g] | [mPa · s] |
| Ex. 1 | 364.0 | 634.0 | 964.0 | 29.0 | 9.8 |
| Ex. 2 | 423.0 | 777.3 | 776.3 | 23.4 | 13.5 |
| Ex. 3 | 354.0 | 650.0 | 975.4 | 20.6 | 9.1 |
| Comp. Ex. 4 | 332.0 | 668.0 | 1000.0 | 0 | 8.9 |

### Polymer Dispersions:

### Polymer Dispersion 1 (Dispersion 1):

### With Vinyltriethoxysilane as Comonomer:

Aqueous, emulsifier-stabilized dispersion of a copolymer based on 59.5% by weight of butyl acrylate, 24% by weight of methyl methacrylate, 11% by weight of styrene, 5% by weight of methacrylic acid and 0.5% by weight of vinyltriethoxysilane having a solids content of 42.4% by weight and a minimum film formation temperature (determined in accordance with DIN ISO 2115) of 5° C.

### Polymer Dispersion 2 (Dispersion 2):

### No Vinyltriethoxysilane Comonomer:

Aqueous, emulsifier-stabilized dispersion of a copolymer based on 60.0% by weight of butyl acrylate, 24% by weight of methyl methacrylate, 11% by weight of styrene and 5% by weight of methacrylic acid having a solids content of 42.4% by weight (DIN EN ISO 3251) and a minimum film formation temperature (determined in accordance with DIN ISO 2115) of 5° C.

### Polymer Compositions:

The formulations for producing the polymer compositions of (comparative) examples 7 to 12 are shown in Table 2. 90 g of the polymer dispersion indicated in Table 2 and optionally an additive in the amounts indicated in Table 2 were used.

To produce the polymer compositions or the additives of (comparative) examples 9 to 12, 11% by weight (solid/solid) of Silres BS 60, based on the solids content of the respective polymer composition, were used in each case.

To produce the polymer compositions, the components indicated in Table 2 were mixed at room temperature and stirred by means of a laboratory stirrer for 4 hours.

### Stability of the Aqueous Hydrophobicizing Agents:

The stability of the hydrophobicizing agents was determined by storing the aqueous dispersions of (comparative) examples 7 to 12 at 50° C. for 4 weeks in each case.

The dispersions of examples 1 to 3 were stable over the entire period of observation, but the dispersion of the comparative example gelled and was thus not storage-stable.

### Stickiness Test:

A polymer film of the respective polymer composition was applied to a Leneta test card in a wet layer thickness of 150 microns and dried at 50% atmospheric humidity and 23° C. for 24 hours. Test pieces were subsequently cut out (3.8×3.8 cm).

The test pieces were placed on top of one another on the coated side and loaded with a weight of one kilogram. After storage at 50% atmospheric humidity and 23′C for 24 hours, the test pieces were separated and visually awarded school grades:

Grade 1: coating not sticky;
Grade 2: coating barely perceptibly sticky;
Grade 3: coating slightly sticky;
Grade 4: coating considerably sticky;
Grade 5: coating highly sticky.

The results of the tests using the polymer compositions of (comparative) examples 7 to 12 are summarized in Table 2.

For use of the polymer compositions in coating compositions, very low stickiness is desired. This is because sticky compositions, for example paints for windows, are not acceptable to users. In addition, sticky coatings tend to take up dirt from the surrounding air. In the extreme case, sticky compositions on, for example, windows can lead to the windows no longer being able to be opened at all.

### Measurement of Dynamic Contact Angle:

A polymer film of the respective polymer composition was applied in a wet layer thickness of 150 microns to a glass plate (4×20 cm) and dried at 50% atmospheric humidity and 23° C. for 24 hours. The coated glass plate was subsequently washed with distilled water and once again dried at 50% atmospheric humidity and 23° C. for 24 hours. The contact angle of the sample obtained in this way was determined using the measuring instrument MobileDrop from Kriss in accordance with DIN 55660.

The dynamic contact angle is an indicator of the hydrophobicization of the coating.

The results of the tests using the polymer compositions of (comparative) examples 7 to 12 are summarized in Table 2.

It can be seen from Table 2 that the polymer compositions of comparative examples 11 and 12, which contain the silicone resin emulsion Silres BS 60, do give coatings having large contact angles and thus good hydrophobicizing properties, but, disadvantageously, the coatings of comparative examples 11 and 12 are very sticky. In contrast, the coatings produced according to the invention using the polymer compositions of examples 9 and 10 are hydrophobicized in the desired way and in addition are barely perceptibly sticky.

TABLE 2
Formulations of the polymer compositions and test results:

| | Polymer | | | Contact |
|---|---|---|---|---|
| | dispersion | Additive | Stickiness | angle |
| Comp. Ex. 7 | Dispersion 1 | — | 1 | 85 |
| Comp. Ex. 8 | Dispersion 2 | — | 1 | 88 |
| Ex. 9 | Dispersion 1 | 23.9 g of Ex. 1 | 2 | 96 |
| Ex. 10 | Dispersion 2 | 23.9 g of Ex. 1 | 2 | 98 |
| Comp. Ex. 11 | Dispersion 1 | 8.0 g of Silres | 5 | 98 |
| | | BS60 | | |
| Comp. Ex. 2 | Dispersion 2 | 8.0 g of Silres | 5 | 99 |
| | | BS60 | | |

1. A polymer composition containing:
one or more silane-containing copolymers; and
one or more hydrophobicizing additives, wherein the hydrophobicizing additives are based on silica, one or more silicone resins and one or more functionalized alkylalkoxysilanes whose alkyl groups bear at least one amino, carboxyl, epoxy or hydroxy group,
wherein the silane-containing copolymers are based on ethylenically unsaturated monomers and include monomer units of ethylenically unsaturated silanes.

2. The polymer composition of claim 1, wherein one or more silicone resins are made up of units of the general formula:
RₐSi(OR′)_{b}(OH)_{c}O_{(4-a-b-c)/2}
where a=0 to 3, b=0 to 3, c=0 to 3,
where the sum of a+b+c per unit is ≤3.5, and
wherein the individual radicals R are identical or different, branched or unbranched alkyl radicals having from 1 to 22 carbon atoms, cycloalkyl radicals having from 3 to 10 carbon atoms, alkylene radicals having from 2 to 4 carbon atoms or aryl, aralkyl, alkylaryl radicals having from 6 to 18 carbon atoms, and
wherein the individual radicals R′ are identical or different alkyl radicals or alkoxyalkylene radicals each having from 1 to 4 carbon atoms,
wherein the radicals R and R′ can also be substituted by halogens such as Cl, ether, thioether, ester, amide, nitrile, hydroxyl, amine, carboxyl, sulfonic acid, carboxylic anhydride and carbonyl groups.

3. The polymer composition of claim 1, wherein the one or more functionalized alkylalkoxysilanes have the general formula:
(R¹O)ₚSi(R²X)₄₋ₚ (I),
where R¹ is a hydrogen atom or a hydrocarbon radical which has from 1 to 18 carbon atoms and can be interrupted by one or more nonadjacent oxygen atoms or is a radical of the formula —COCH₃, —COC₂H₅ or —CH₂CH₂OH,
R² is an optionally substituted alkylene radical which has from 1 to 20 carbon atoms, in which nonadjacent methylene units can be replaced by oxygen and
X is bound via a covalent bond to R² and is an amino radical —NHR³, an epoxy radical —CR⁴(O)CR⁵R⁶, a carboxyl radical —COOH or a hydroxy radical —OH,
where R³ is a hydrogen atom or an optionally substituted alkyl, aryl or aminoalkyl radical having from 1 to 10 carbon atoms,
R⁴, R⁵, R⁶ are each a hydrogen atom or an optionally substituted alkyl or aryl radical having from 1 to 10 carbon atoms,
where the respective radicals R¹, R², R³, R⁴, R⁵ and R⁶ can each assume their meanings independently of one another and
R²X is bound via a carbon atom of the radical R² to the silicon atom in the formula 1.

4. The polymer composition of claim 1, wherein the one or more functionalized alkylalkoxysilanes are selected from the group consisting of (3-aminopropyl)triethoxysilane, (3-aminopropyl)trimethoxysilane, N-(2-aminoethyl)(3-aminopropyl)triethoxysilane, N-(2-aminoethyl)(3-aminopropyl)trimethoxysilane, N-(2-aminoethyl)(3-aminopropyl)methyldimethoxysilane, N-cyclohexylaminomethylmethyldiethoxysilane, (3-glycidoxypropyl)triethoxysilane, and 3-glycidoxypropyl)trimethoxysilane.

5. The polymer composition claim 1, wherein the hydrophobicizing additive is based on from 10 to 90% by weight of silicone resin, based on the dry weight of the hydrophobicizing additive.

6. The polymer composition claim 14, wherein the hydrophobicizing additive is based on from 10 to 90% by weight of silica, based on the dry weight of the hydrophobicizing additive.

7. The polymer composition claim 1, wherein the hydrophobicizing additive is based on from 0.1 to 10% by weight on the functionalized alkylalkoxysilanes, based on the proportion of silica in the hydrophobicizing additive (dry/dry).

8. The polymer composition of claim 1, wherein the hydrophobicizing additive is based on from 0.1 to 10% by weight on the functionalized alkylalkoxysilanes, based on the proportion of silica and silicone resin in the hydrophobicizing additives (dry/dry).

9. The polymer composition of claim 1, wherein from 1 to 40% by weight of hydrophobicizing additives are present, based on the dry weight of the polymer composition.

10. The polymer composition of claim 1, wherein from 60 to 99% by weight of polymers of ethylenically unsaturated monomers are present, based on the dry weight of the polymer composition.

11. A method for producing the polymer composition of claim 1, comprising mixing one or more hydrophobicizing additives with one or more silane-containing copolymers.

12. The method for producing the polymer composition of claim 11, wherein the one or more hydrophobicizing additives are produced by mixing silica, one or more silicone resins and one or more functionalized alkylalkoxysilanes whose alkyl groups bear at least one amino, carboxyl, epoxy or hydroxy group.

13. A composition containing composite particles and based on silica, one or more silicone resins, one or more functionalized alkylalkoxysilanes whose alkyl groups bear at least one amino, carboxyl, epoxy or hydroxy group and one or more silane-containing copolymers which are based on ethylenically unsaturated monomers and contain monomer units of ethylenically unsaturated silanes,
wherein one or more composite particles are obtained by condensation of silica and/or silicone resins with one or more silane-containing copolymers in an aqueous solvent, with one or more silane-containing copolymers being fixed onto silica and/or silicone resins as a result of the condensation, are present.

14. (canceled)

15. The polymer composition of claim 1, wherein the polymer composition if a coating or an additive for a coating composition such as varnishes, paints, sealants or for the coating of fibers, textiles or paper.
